(19) United States
(12) Patent Application Publication
(10) Pub. No.: US 2019/0077215 A1
(43) Pub. Date: Mar. 14, 2019

(54) SYSTEM AND METHOD FOR PERSONALIZED THERMAL COMFORT IN A VEHICLE PASSENGER CABIN

(71) Applicant: FORD GLOBAL TECHNOLOGIES, LLC, Dearborn, MI (US)

(72) Inventors: Hyung Min Baek, Sunnyvale, CA (US); John Craig Elson, Bloomfield Township, MI (US); James George Gebbie, Rochester Hills, MI (US)

(21) Appl. No.: 15/702,110

(22) Filed: Sep. 12, 2017

(51) Int. Cl. B60H 1/00; B60H 1/24

(52) U.S. Cl. CPC B60H 1/00371; B60H 1/00064; B60H 1/245

(57) ABSTRACT

A personalized thermal comfort system includes an air registration system, configured to establish discrete air curtains around individual seats in a vehicle passenger cabin, and an HVAC system. The HVAC system functions to condition air flowing in the discrete air curtains. The HVAC system includes a controller configured to allow a seat occupant to individually control the conditioning of air in the air curtain associated with the occupied seat. A related method is also disclosed.

### TECHNICAL FIELD

This document relates generally to the vehicle equipment field and, more particularly, to a personalized thermal comfort system as well as to a related method for providing personalized thermal comfort for occupants of a vehicle passenger cabin. Although the system and method are useful for any type of vehicle, the system and method are particularly advantageous when used in multi-passenger ride-share vehicles.

### BACKGROUND

Vehicle occupants typically have varying temperature preferences. This is particularly true when multiple rows of occupants inhabit a ride-share vehicle.

Current climate control systems offer limited heating/cooling capability to tailor from occupant to occupant thereby limiting occupant comfort. In ride-share vehicles, this problem is confounded by frequent door opening and closing which tends to make climate control more difficult and less efficient.

This document relates to a new and improved personalized thermal comfort system and related method for providing personalized thermal comfort for occupants of a vehicle passenger cabin including those in a ride-share vehicle. As will become apparent from the following description, the personalized thermal comfort system and method allow for the generation of discrete air curtains around each occupant under the individual control of each occupant to allow for enhanced comfort.

### SUMMARY

In accordance with the purposes and benefits described herein, a personalized thermal comfort system is provided. That personalized thermal comfort system comprises an air register system, configured to establish discrete air curtains around individual seats in a vehicle passenger cabin, and an HVAC system for conditioning air flowing in the discrete air curtains. The HVAC system includes a controller configured to allow an individual occupant in one of the individual seats to individually control the conditioning of the air in an individual air curtain associated with that one seat.

The air register system may include a first register above a first seat and a second register below the first seat whereby a first discrete air curtain is established about the first seat and the occupant seated thereupon.

The personalized thermal comfort system may further include a first air circulation fan in the first seat for displacing the air in the first discrete air curtain between the first register and the second register. In some of the many possible embodiments, the first register may be a first air discharge register, the second register may be a first air return register and the first air circulation fan may displace air in the first discrete air curtain in a first predominantly vertical path from above the first seat to below the first seat.

The controller of the personalized thermal comfort system may be configured to provide wireless communication with a first personal communication device, such as a smart phone, of a first individual occupant seated in the first seat. This allows the first individual occupant to utilize the first personal communication device to control the conditioning of the air flowing in the first discrete air curtain. Thus, the first individual occupant is able to optimize the air in the first discrete air curtain to maximize the first individual's comfort without regard to or without affecting the comfort of other individuals in the vehicle passenger cabin.

Still further, the air register system may include a third register above a second seat and a fourth register below the second seat whereby a second discrete air curtain is established about the second seat. In addition, the personalized thermal comfort system may include a second air circulation fan in the second seat. The second air circulation fan functions to displace air in the second discrete air curtain between the third register and the fourth register.

In such an embodiment, the third register may be a second air discharge register, the fourth register may be a second air return register and the second air circulation fan may displace air in the second discrete air curtain in a second predominantly vertical path from above the second seat to below the second seat.

Still further, the controller may be configured to provide wireless communication with a second personal communication device of a second individual occupant seated in the second seat. This allows the second individual occupant to utilize that second personal communication device to control the conditioning of the air flowing in the second discrete air curtain over and around the second seat.

In any of the many possible embodiments of the personalized thermal comfort system, the first air circulation fan may draw the air of the first discrete air curtain into a first seat back of the first seat and discharge that air from a first seat bottom of the first seat downwardly toward the floor of the motor vehicle and the second register. Similarly, the second air circulation fan may be configured to draw air from the second discrete air curtain into a second seat back of the second seat and discharge that air from the second seat bottom of the second seat toward the floor and the fourth air register.

Consistent with the above description, a method is provided for enhancing the personalized thermal comfort for occupants of a motor vehicle. That method may be broadly described as comprising the steps of establishing, by an air register system, a first discreet air curtain around a first occupant and a second discrete air curtain around a second occupant and configuring a controller to allow the first occupant to control conditioning of air in the first air curtain and the second occupant to control conditioning of air in the second air curtain.

The method may further include moving the air in the first discrete air curtain along a first predominantly vertical path and moving the air in the discrete air curtain along a second predominantly vertical path.

In addition, the method may include moving, by a first air circulation fan, the air in the first discrete air curtain through a first seat in which the first occupant is seated. Further, the method may include the step of moving, by a second air circulation fan, the air in the second discrete air curtain through a second seat in which the second occupant is seated.

Thus, the method may include moving the air in the first discrete air curtain downward from above the first seat through the first seat to below the first seat. In addition, the method may include the step of moving the air in the second discrete air curtain downward from above the second seat through the second seat to below the second seat. Moving the air in the first discrete air curtain through the first seat helps establish a first envelope of first air curtain air around the first individual. Movement of air through the second seat helps establish a discrete envelope of second air curtain air around a second individual in the second seat. This helps to maximize the individual comfort of the occupants of the motor vehicle.

The method may also include the step of configuring the controller to allow for wireless communication with a first personal communication device of the first occupant whereby the first occupant may control conditioning of the air in the first discrete air curtain. Similarly, the method includes configuring the controller to allow for wireless communication with a second personal communication device of the second occupant whereby the second occupant may control conditioning of the air in the second discrete air curtain.

In some of the many possible embodiments, the method may further include the steps of drawing, by the first air circulation fan, the air of the first discrete air curtain into a first seat back and first upper surface of a first seat bottom of the first seat and drawing, by the second air circulation fan, the air of the second discreet air curtain into a second seat back and second upper surface of a second seat bottom of the second seat.

For purposes of this document, the term “vehicle” shall include any machine that carries people or goods from one place to another. “Vehicle passenger cabin” shall refer to any area of any vehicle adapted to carry one or more passengers.

In the following description, there are shown and described several preferred embodiments of the personalized thermal comfort system and the related method for providing personalized thermal comfort for occupants of a vehicle passenger cabin. As it should be realized, the personalized thermal comfort system and related method are capable of other, different embodiments and their several details are capable of modification in various, obvious aspects all without departing from the personalized thermal comfort system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the personalized thermal comfort system and related method for providing personalized thermal comfort for occupants of a vehicle passenger cabin and together with the description serve to explain certain principles thereof.

FIG. 1a is a schematic side elevational view illustrating a first occupant sitting in a first seat and enveloped in a first discrete air curtain with air flowing in a predominantly vertical direction from a first register above the seat through the first seat to a second register below the first seat.

FIG. 1b is a schematic illustration of the control architecture for the personalized thermal comfort system shown in FIG. 1a.

FIG. 1c is a schematic block diagram of a controller that may be utilized as a part of the HVAC system of the personalized thermal comfort system.

FIG. 2 is a cross-sectional view of a ride-share vehicle illustrating four individual seats with each seat having its own discrete air curtain.

FIG. 3a is a first detailed view of one possible embodiment of the personalized thermal comfort system for moving airflow through the seat.

FIG. 3b is a view similar to 3a but illustrating another possible embodiment for the same purpose.

Reference will now be made in detail to the present preferred embodiments of the personalized thermal comfort system and method, examples of which are illustrated in the accompanying drawing figures.

### DETAILED DESCRIPTION

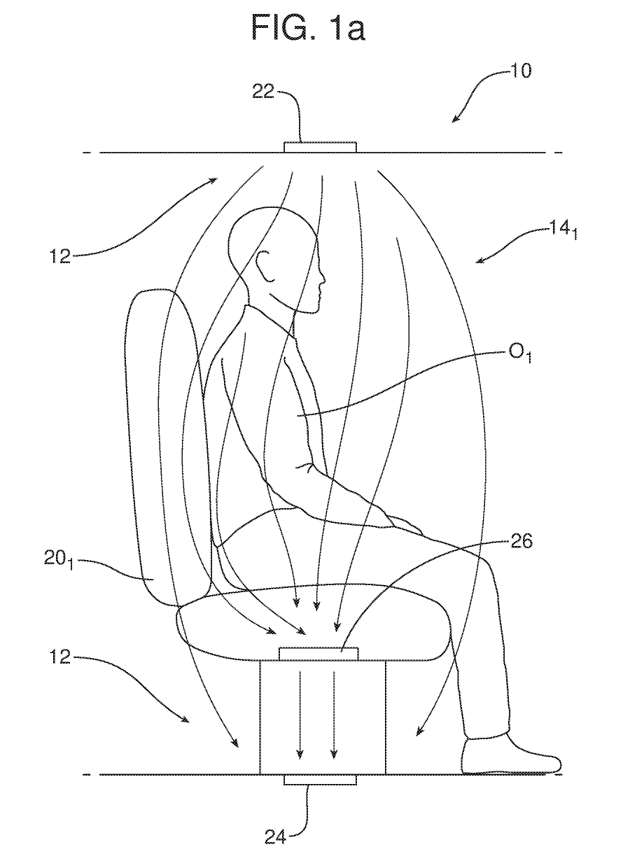

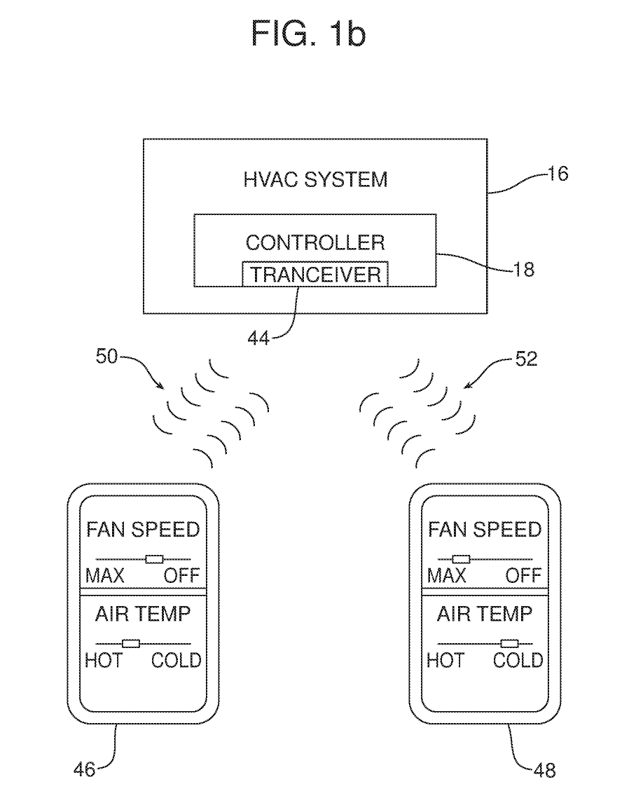

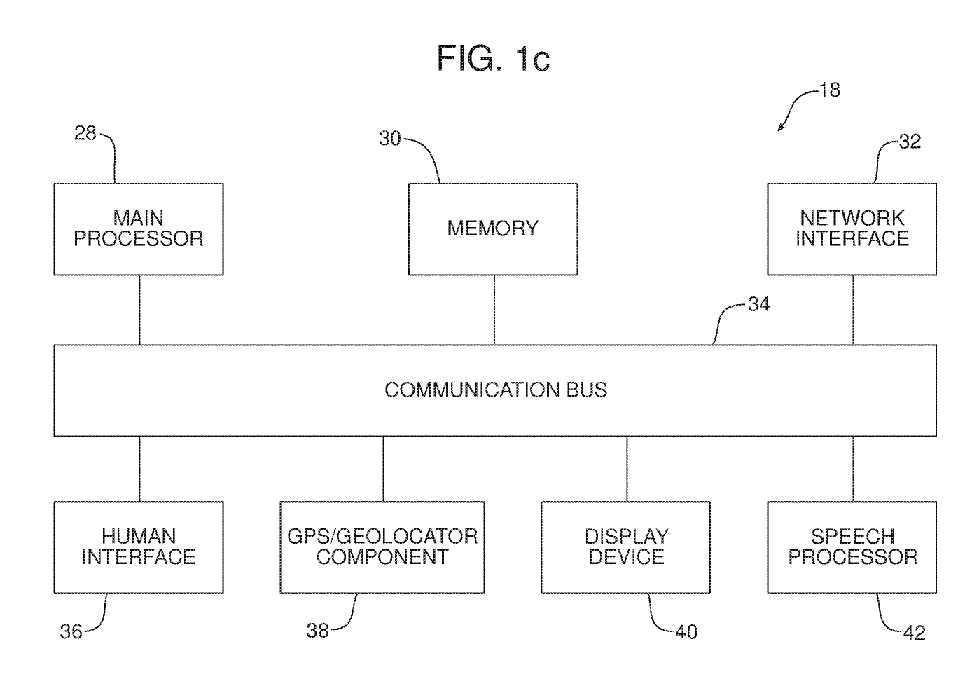

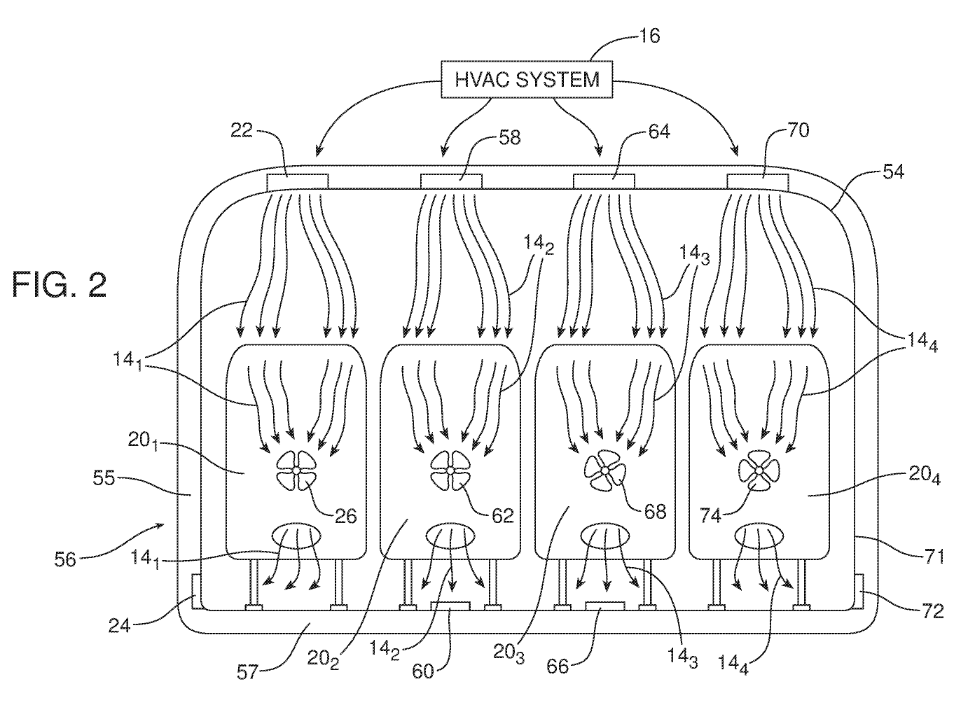

Reference is now made to FIGS. 1a-1c and 2 illustrating the new and improved personalized thermal comfort system 10. That personalized thermal comfort system 10 includes an air register system, generally designated by reference numeral 12, configured to establish discrete air curtains 14₁-14ₙ around individual seats in a vehicle passenger cabin. The personalized thermal comfort system 10 also includes a heating, ventilating and air conditioning (HVAC) system 16 for conditioning air flowing in the discrete air curtains 14₁-14ₙ.

As illustrated in FIG. 1a, the air register system 12 includes a first register 22 above the first seat 20₁ and a second register 24 below the first seat whereby the first discrete air curtain 14₁ is established about the first seat.

As further illustrated in FIG. 1a, a first air circulation fan 26 is provided in the first seat 20₁ for displacing air in the first discrete air curtain 14₁ between the first register 22 and the second register 24. In the embodiment illustrated in FIG. 1, the first register 22 is a first air discharge register, the second register 24 is a first air return register and the first air circulation fan 26 displaces air in the first discrete air curtain 14₁ in a first predominantly vertical path from above the first seat 20₁ to below the first seat. Such a vertically oriented first air curtain 14₁ flows over and around only the first occupant O₁ of that first seat 20₁ providing an exclusively personal airflow. In contrast, predominantly horizontally directed airflows of state-of-the-art air conditioning systems provide an airstream flowing across multiple individuals seated in multiple rows of the motor vehicles and thus cannot be personalized for the comfort of any particular individual.

As best illustrated in FIG. 1b, the HVAC system 16 includes a controller 18 configured to allow an individual occupant in one of the individual seats 20₁-20ₙ to individually control conditioning of air in the individual air curtain 14₁-14ₙ associated with the one seat of the individual seats in which the individual is seated.

The controller 18 may comprise a computing device such as a dedicated microprocessor or electronic control unit (ECU) operating in accordance with instructions from appropriate control software. As illustrated in FIG. 1c, the controller 18 may comprise one or more processors 28, one or more memories 30 and one or more network interfaces 32 all in communication with each other over a communication bus 34. In some embodiments, the controller 18 may also comprise a human interface 36, a GPS/geolocator component 38, a display device 40 such as multifunction display with touchscreen capability and a speech processor 42 also communicating over the communication bus 34. In some embodiments, the controller 18 may comprise a body control module or BCM of the motor vehicle. Such a controller performs a number of interior body electrically based functions including, for example, interior locking, remote key entry, interior lighting, exterior lighting, windshield wiper control and the like. In some embodiments, such a BCM controller 18 may also function to control entertainment functions (e.g., radio, CD player) and communications such as telephone and internet communications over a wireless network. In some embodiments a BCM controller 18 is connected by a communication bus (not shown) to other control modules that provide one or more of these additional functions.

A speech processor 42 is particularly beneficial as it allows for voice commands respecting operation of the personalized thermal comfort system. In other embodiments, such as illustrated in FIG. 1b, the controller 18 includes or is connected to a transceiver 44 allowing for wireless communication between the controller and the personal communication devices of the individual occupants of a vehicle passenger cabin equipped with the personalized thermal comfort system 10. In FIG. 1b, a first personal communication device, such as a smart phone, of a first individual occupant is identified at 46 and a second personal communication device of a second individual occupant is indicated at 48. Wireless communication signals between the controller 18 and the first personal communication device 46 are illustrated at 50. Wireless communication signals between the controller 18 and the second personal communication device 48 are illustrated at 52.

Reference is now made to FIG. 2 which schematically illustrates a vehicle passenger cabin 54 of a motor vehicle 56 including a first seat 20₁, a second seat 20₂, a third seat 203 and a fourth seat 20₄. The first register 22 is provided above the first seat. The second register 24 is provided below the first seat in the sidewall 55 of the motor vehicle adjacent the floor 57 and the first air circulation fan 26 is provided within the first seat.

A third register 58 is provided above the second seat, a fourth register 60 is provided below the second seat 20₂ and a second air circulation fan 62 is provided in the second seat.

A fifth register 64 is provided above the third seat 203, a sixth register 66 is provided below the third seat and a third air circulation fan 68 is provided in the third seat. A seventh register 70 is provided above the fourth seat 20₄, an eighth register 72 is provided below the fourth seat (in the sidewall 71 adjacent the floor 57) and a fourth air circulation fan 74 is provided in the fourth seat.

As should be appreciated from viewing FIG. 2, conditioned air from the HVAC system 16 is delivered under positive pressure through the first register 22 above the first seat 20₁, then drawn in a discrete envelope around any occupant in the first seat by the first air circulation fan 26 before being discharged through the bottom of the first seat toward the second register 24 thereby establishing a first discrete air curtain 14₁.

Similarly, conditioned air from the HVAC system 16 is discharged under positive pressure through the third register 58 above the second seat 20₂, then drawn around any occupant in the second seat into the second seat by the second air circulation fan 62 before being discharged from the bottom of the second seat toward the fourth register 60. Thus, it should be appreciated that a second discrete air curtain 14₂ is provided around any occupant sitting in the second seat 202.

The fifth register 64, third air circulation fan 68 and sixth register 66 function in a similar manner to envelope any individual sitting in the third seat 203 with air of a third discrete air curtain 14₃. The seventh register 70, fourth air circulation fan 74 and eighth register 72 are configured in the same manner to create a fourth discrete air curtain 14₄ around any occupant sitting in the fourth seat 20₄. The various occupants in the individual seats 20₁-20₄ may utilize their personal communication devices 46, 48 or any human interface 36 or touchscreen display device 40, provided in the vehicle passenger cabin 54 and dedicated to control the particular air curtain 14₁-14₄ of the seat 20₁-20₄ in which they are sitting, in order to control the temperature and intensity of the air delivered by the HVAC system 16 and flowing through their own individual discrete air curtain 14₁-14₄.

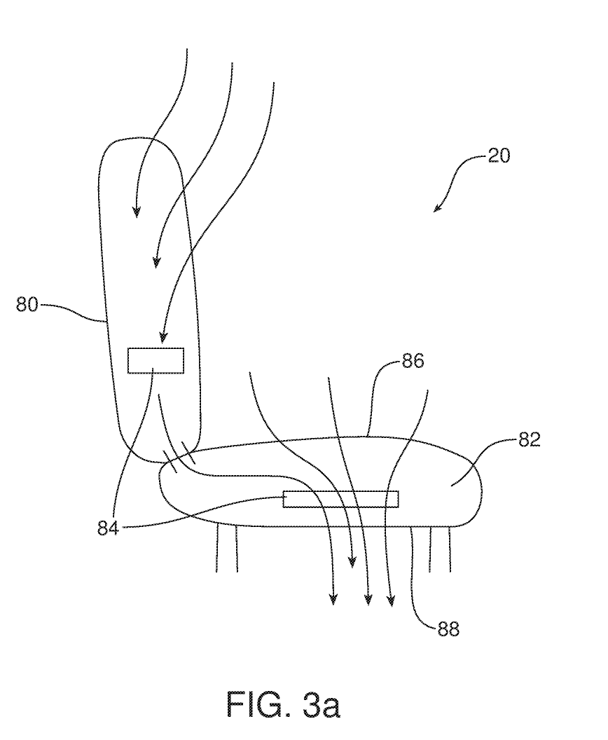

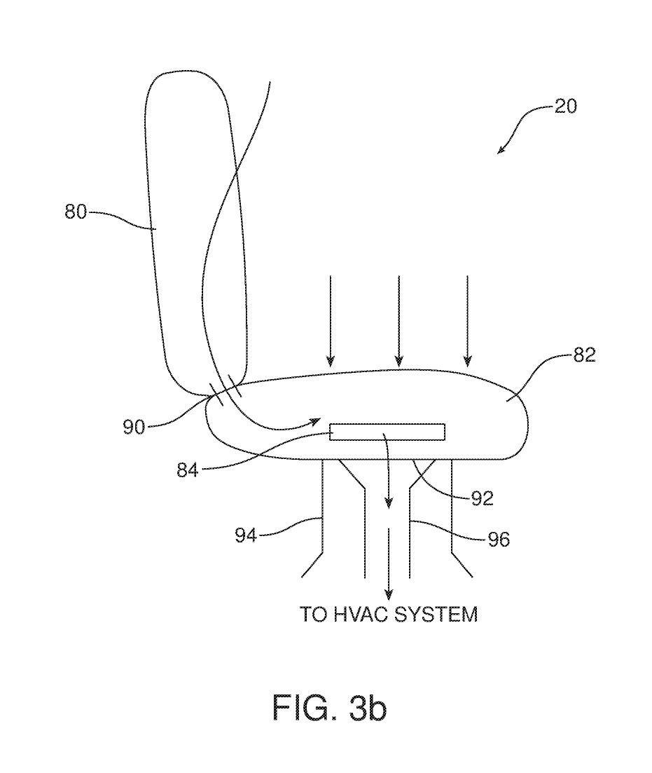

FIG. 3a is a detailed illustration of a seat 20 including a seat back 80 and a seat bottom 82. As illustrated by the action arrows, air of the discrete air curtain flowing over and around the seat 20 may be drawn by an air circulation fan 84 through the seat back 80 and a surface 86 (e.g. upper surface, side surface or even the base) of the seat bottom 82. The air circulation fan 84 then discharges that air through the lower surface 88 of the seat bottom 82. In the illustrated embodiment, the air circulation fan 84 comprises a single unit in the seat back, a single unit in the seat bottom or dual units with one in the seat back and one in the seat bottom.

Reference is now made to FIG. 3b illustrating an alternative embodiment wherein the seat 20 includes a single air circulation fan 84 in the seat bottom 82 that draws air through the seat back 80 and the seat bottom 82 (note air conduit 90) allowing for the passage of air drawn through the seat back 80 into the seat bottom 82. The air is discharged by the air circulation fan 84 through a discharge port 92. As illustrated in FIG. 3b, the discharge port 92 may be directly connected to an air register 96 in the seat pedestal 94 that returns air to the HVAC system 16 for reconditioning.

In summary, numerous benefits and advantages are provide by the personalized thermal comfort system 10 and related method disclosed herein. The vertically oriented air curtains 14₁-14ₙ are discrete to each seat 20₁-20₁ and each occupant sitting in each seat. The personalized thermal comfort system 10 allows each occupant of each seat 20₁-20ₙ to individually control the intensity and temperature of the air provided from the HVAC system 16 and/or the fan speed of the air circulation fan of the seat in which the occupant is sitting to establish each discrete air curtain 14₁-14ₙ. This allows each individual occupant to customize that airflow to maximize their own personal comfort without detriment to the personal comfort of other occupants in the vehicle passenger cabin 54.

The foregoing has been presented for purposes of illustration and description. It is not intended to be exhaustive or to limit the embodiments to the precise form disclosed. Obvious modifications and variations are possible in light of the above teachings. For example, air of the discrete air curtains 14₁-14ₙ may be drawn through any portion of the seat 20₁-20ₙ by an air circulation fan 26, 62, 68, 74 and directed downward from the seat toward the register beneath the seat for returning air to the air conditioning system 16. Toward this end, the air may be drawn through perforations, vents, louvers or other openings provided in the seats 20₁-20ₙ along substantially any surface and in substantially any location as desired. In other embodiments, the air circulation fan 26, 62, 68, 74 in the seat 20₁-20ₙ may be deleted from the system. In such embodiments, an air circulation or suction fan may be provided in the air return line immediately behind the air return register if desired. Alternatively, return air circulation or suction may be provided exclusively by the HVAC system 16. Still further, it should be appreciated that the airflow direction does not have to be downward. It could be upward or in some other direction as desired. All such modifications and variations are within the scope of the appended claims when interpreted in accordance with the breadth to which they are fairly, legally and equitably entitled.

What is claimed:

1. A personalized thermal comfort system, comprising:
an air register system configured to establish discrete air curtains around individual seats in a vehicle passenger cabin; and
an HVAC system for conditioning air flowing in said discrete air curtains, said HVAC system including a controller configured to allow an individual occupant in one seat of said individual seats to individually control conditioning of air in an individual air curtain associated with said one seat.

2. The personalized thermal comfort system of claim 1, wherein said air register system includes a first register above a first seat and a second register below said first seat whereby a first discrete air curtain is established about said first seat.

3. The personalized thermal comfort system of claim 2, further including a first air circulation fan in said first seat for displacing said air in said first discrete air curtain between said first register and said second register.

4. The personalized thermal comfort system of claim 3, wherein said first register is a first air discharge register, said second register is a first air return register and said first air circulation fan displaces air in said first discrete air curtain in a first predominantly vertical path from above said first seat to below said first seat.

5. The personalized thermal comfort system of claim 4, wherein said controller is configured to provide wireless communication with a first personal communication device of a first individual occupant seated in said first seat whereby said first individual occupant may control said conditioning of said air flowing in said first discrete air curtain.

6. The personalized thermal comfort system of claim 5, wherein said air register system includes a third register above a second seat and a fourth register below said second seat whereby a said discrete air curtain is established about said second seat.

7. The personalized thermal comfort system of claim 6, further including a second air circulation fan in said second seat for displacing said air in a second discrete air curtain between said third register and said fourth register.

8. The personalized thermal comfort system of claim 7, wherein said third register is a second air discharge register, said fourth register is a second air return register and said second air circulation fan displaces air in said second discrete air curtain in a second predominantly vertical path from above said second seat to below said second seat.

9. The personalized thermal comfort system of claim 8, wherein said controller is configured to provide wireless communication with a second personal communication device of a second individual occupant seated in said second seat whereby said second individual occupant may control conditioning of said air flowing in said second discrete air curtain.

10. The personalized thermal comfort system of claim 9, wherein said first air circulation fan draws said air of said first discrete air curtain into said first seat back of said first seat and discharges said air from a first seat bottom of said first seat.

11. The personalized thermal comfort system of claim 10, wherein said second air circulation fan draws said air of said second discrete air curtain into said second seat back of said second seat and discharges said air from a second seat bottom of said second seat.

12. A method for providing personalized thermal comfort for occupants of a vehicle passenger cabin, comprising:
establishing, by an air register system, a first discrete air curtain around a first occupant and a second discrete air curtain around a second occupant; and
configuring a controller to allow said first occupant to control conditioning of air in said first discrete air curtain and said second occupant to control conditioning of air in said second discrete air curtain.

13. The method of claim 12, further including moving air in said first discrete air curtain along a first predominantly vertical path and moving said air in said second discrete air curtain along a second predominantly vertical path.

14. The method of claim 13, further including moving, by a first air circulation fan, said air in said first discrete air curtain through a first seat in which said first occupant is seated.

15. The method of claim 14, further including moving, by a second air circulation fan, air in said second discrete air curtain through a second seat in which said second occupant is seated.

16. The method of claim 15, further including moving said air in said first discrete air curtain downward from above said first seat, through said first seat to below said first seat.

17. The method of claim 16, further including moving said air in said second discrete air curtain downward from above said second seat, through said second seat to below said second seat.

18. The method of claim 16, further including configuring said controller to allow for wireless communication with a first personal communication device of said first occupant whereby said first occupant may control conditioning of said air in said first discrete air curtain.

19. The method of claim 18, further including configuring said controller to allow for wireless communication with a second personal communication device of said second occupant whereby said second occupant may control conditioning of said air in said second discrete air curtain.

20. The method of claim 19, further including drawing, by said first air circulation fan, said air of said first discrete air curtain into a first seat back and first surface of a first seat bottom of said first seat and drawing, by said air circulation fan, said air of said second discrete air curtain into a second seat back and second surface of a second seat bottom of said second seat.
